(19) United States
(12) Patent Application Publication
(10) Pub. No.: US 2015/0262481 A1
(43) Pub. Date: Sep. 17, 2015

(54) SYSTEM AND METHOD TO DETERMINE OCCURRENCE OF PLATOON

(71) Applicant: SCANIA CV AB, Södertälje (SE)

(72) Inventor: Erik Selin, Segeltorp (SE)

(21) Appl. No.: 14/435,547

(22) PCT Filed: Oct. 9, 2013
(86) PCT No.: PCT/SE2013/051188

§ 371 Date: Apr. 14, 2015

(30) Foreign Application Priority Data
Oct. 15, 2012 (SE) 1251163-0

(51) Int. Cl. G08G 1/01; G08G 1/00

(52) U.S. Cl. CPC G08G 1/0133; G08G 1/22

(57) ABSTRACT

Disclosed is a method for determining the occurrence of platoons, comprising: providing several sets of vehicle data in relation to a number of vehicles; comparing the sets of vehicle data for the group of vehicles with at least one limit value for the sets of vehicle data; identifying at least a selection of vehicles from the group of vehicles depending on the result of the comparison; calculating the distances between the vehicles in the selection of vehicles, and determining the relative positions for the vehicles in the selection of vehicles based on at least said calculated distances.

### CROSS-REFERENCE TO RELATED APPLICATIONS

The present application is a 35 U.S.C. §§371 national phase conversion of PCT/SE2013/051188, filed Oct. 9, 2013, which claims priority of Swedish Patent Application No. 1251163-0, filed Oct. 15, 2012, the contents of which are incorporated by reference herein. The PCT International Application was published in the English language.

### FIELD OF THE INVENTION

The present invention pertains to the field of platoons, and specifically to a system and a method to determine the occurrence of platoons.

### BACKGROUND OF THE INVENTION

Traffic intensity is high on Europe's major roads and is expected to increase in the future. The energy requirement for transport of goods on these roads is also enormous and growing. One way to resolve these problems is to allow trucks to travel closer in so-called platoons. Since the trucks in the platoon are transported closer together, the air resistance decreases considerably, the energy requirement is reduced, and the transport system is used more efficiently. Other vehicles, such as for example cars, may also benefit from travelling in platoons. A platoon in this context means a number of vehicles driven with short distances between each other and progressing as one unit.

The fuel consumption for vehicles in a platoon is thus reduced as a consequence of reduced air resistance. The reduced fuel consumption results in a corresponding reduction of CO₂ emissions. Depending on where in the platoon a vehicle is located, fuel consumption is reduced by different amounts. The savings may also differ depending on the state of the road. The fuel reduction may also be a result of the driver's special style of driving. In order to determine the value of driving in a platoon along different roads, and also the significance of the position held by a vehicle, there is a need to provide guidelines in a simple way which the driver may follow. In order to evaluate driving in a platoon, platoons must first be detected. The detection of platoons is difficult among other things because there are different lanes with meeting or parallel traffic, which means it is difficult to distinguish vehicles in a platoon from vehicles outside of it based on position data.

In “Discovery of Convoys in Trajectory Databases”, E. Jeung et al., Proceedings of the VLDB Endowment VLDB Endowment Volume 1 Issue 1, August 2008, p. 1068-1080, a method for detecting vehicle convoys is described. The method uses density based notations. Three algorithms are presented, in which trajectories are calculated for the different vehicles, as well as distance limits between the different trajectories. In a refinement step candidate convoys are processed in order to identify real convoys.

In “Accurate Discovery of Valid Convoys from Moving Object Trajectories”, H. Yoon and C. Shahabi, IEEE International Conference on Data Mining Workshops, 6 Dec. 2009, p. 636-643, a method for detecting vehicle convoys is described. The method comprises two phases. In the first phase partially connected convoys are distinguished from a given set of moveable objects, and in the second phase the density connection for each partial connected convoy is validated in order to finally identify a complete set of real convoys.

In “Performances in Multitarget Tracking for Convoy Detection over Real GMTI data”, E. Pollard et al, 13^{th} Conference on Information Fusion, 26-29 Jul. 2010, a dynamic Bayesian network is used, which processes the probability that collections of vehicles constitute a convoy. GMTI-data (Ground Moving Target Indicator-data) is used to detect collections of vehicles.

The above described methods require extensive data processing and excessive processor power. Since position data from a large number of vehicles must be used, it is important to be able to process these efficiently in order to quickly obtain the information desired.

An objective of the invention is thus to provide an improved method for obtaining information regarding the occurrence of platoons from a large quantity of data. Through the method and the computer system it is possible, for each vehicle position, to specify the location of such position within the platoon and the distance to the other vehicles in the platoon, when it has been concluded that a platoon exists. This is done in order to calculate the fuel saving achieved by driving in the platoon and to compare how much fuel is saved depending on where in the platoon the vehicle is driving.

### SUMMARY OF THE INVENTION

According to one aspect, the above described objective is achieved through a method that determines the occurrence of platoons. The method may advantageously be implemented in a computer.

According to another aspect, the objective is achieved with a computer system that determines the occurrence of a platoon, which computer system comprises a memory device and a processor device which is configured to communicate with said memory device. The processor device is configured to carry out the above-noted method, which will be described in the detailed description.

Through the method and the computer system, it is possible to determine whether there is a platoon by using a large amount of data for numerous vehicles. Preferably, there is a time series with vehicle data including position information and directional information for each vehicle. Through the method and the computer system it is possible to specify the location of the position of each vehicle within the platoon and the distance to the other vehicles in the platoon when it is concluded that a platoon exists.

The result may be used by, for example, hauling companies and vehicle pools to identify driving patterns and for route planning. By comparing the result with the fuel consumption of the vehicles, it is possible to calculate the fuel saving achieved by driving in the platoon. The saving for different positions in the platoon may be compared in order to derive the amount of saving generated depending on whether the vehicle is located first, last or in the middle of the platoon, or when it is not travelling in a platoon at all, respectively. The suitability of different roads for platoons may also be evaluated. The result may then, for example, be used as recommendations for drivers, or route planning for drivers and/or hauling companies.

Preferred embodiments are described in the dependent claims and in the detailed description.

### BRIEF DESCRIPTION OF THE ENCLOSED FIGURES

The invention is described below with reference to the enclosed figures, of which:

FIG. 1 shows a flow diagram for a method according to one embodiment of the present invention.

FIG. 2 shows a coordinate system, which is used according to one embodiment of the invention.

FIG. 3 shows a coordinate system, which is used according to one embodiment of the invention.

FIG. 4 shows schematically a computer system according to an embodiment of the present invention.

### DETAILED DESCRIPTION OF PREFERRED EMBODIMENTS OF THE INVENTION

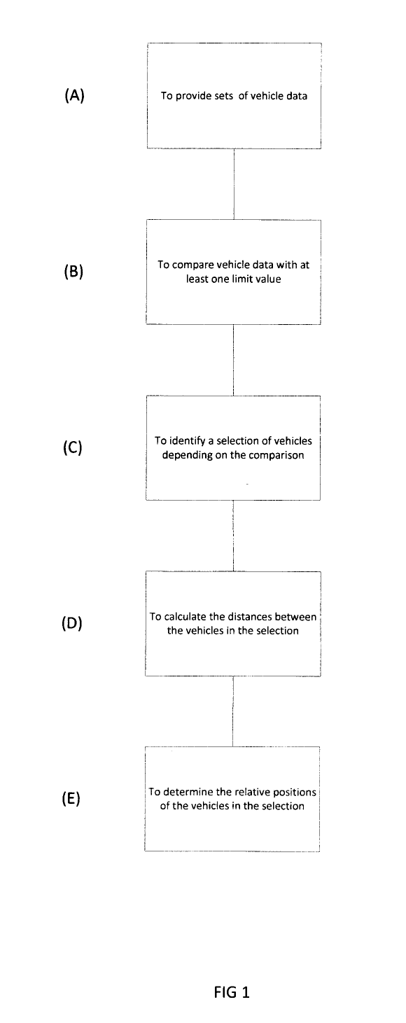

FIG. 1 shows a flow diagram for a method to determine the occurrence of platoons, which will now be described with reference to this figure. In a first step A, a number of sets of vehicle data relating to a number of vehicles is provided. These sets of vehicle data are, according to one embodiment, collected from a database, which may comprise a large number of sets of vehicle data. The sets collected may, for example, be limited to a specific geographical area, for example a specific road section and/or a specific time period. Vehicle data may, for example, comprise one or several of identity, position data, directional data and time data for each vehicle in the group. According to another embodiment, the vehicle data is collected from the vehicles in question directly or via a road side device through wireless communication.

In a second step B, the sets of vehicle data for the vehicles in the group are compared with at least one limit value for the sets of vehicle data. Depending on the vehicle data in question, the limit values are used for this. The limit value or values may, for example, comprise limit values for position data, directional data and/or time data. According to one embodiment, the limit value or values are based on a reference vehicle V₀ in the group of vehicles, which will be explained in more detail below. By replacing the reference vehicle V₀ with new vehicles in the group of vehicles, all or parts of the group may be reviewed in order to determine the occurrence of platoons.

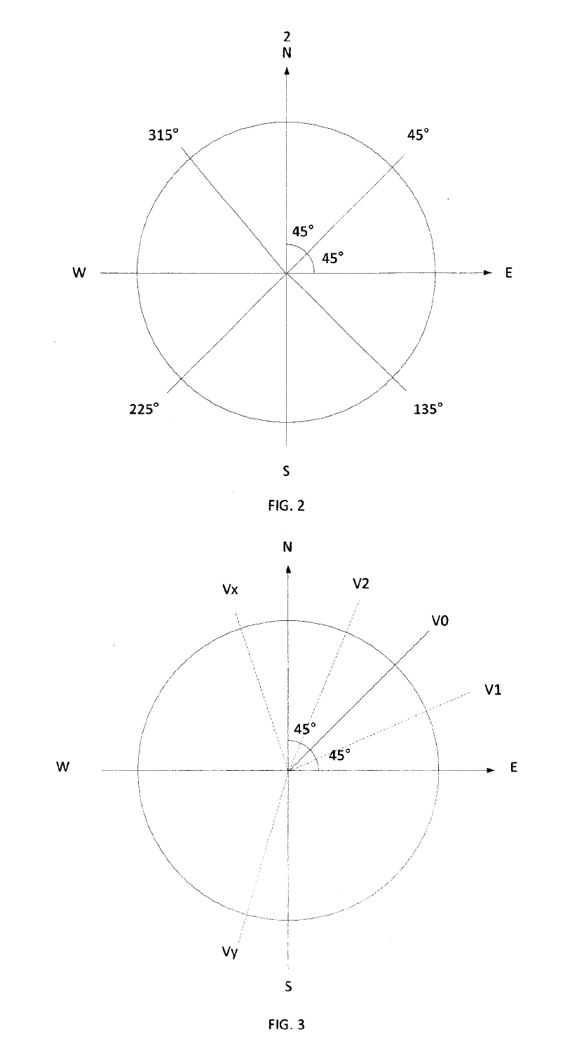

According to one embodiment, the position data is obtained via a positioning system, e. g. GPS (Global Positioning System) and comprises geographical coordinates for the respective vehicles. By using a positioning system, time stamped vehicle positions may be obtained, and thus the vehicle positions may be time synchronised. According to one embodiment, the directional data comprises a degree, where 0° corresponds to a northern direction N, 270° corresponds to a western direction W, 180° corresponds to a southern direction S, and 90° corresponds to an eastern direction E, as illustrated in FIG. 2. The time data thus preferably comprises the time when the position data was determined.

According to one embodiment, a limit value for time data comprises a time difference value Delta Time between two vehicles. According to one embodiment, the limit value for the time data is between 100 ms and 500 ms, for example, 200 ms, 300 ms or 400 ms. The method then comprises determining the difference in time between two vehicles, and comparing this difference with the limit value for the time data. Thus, it is possible to obtain a synchronised reporting of vehicle data in order to determine the positions within a platoon, and also to reduce the risk that another vehicle, which was located on the relevant road section at approximately the same time as the vehicles, is included in the platoon even though it is not participating in the platoon.

According to one embodiment, a limit value for position data comprises a maximum distance MaxDist between two vehicles. The method comprises a determination of the difference in distance between two vehicles, and a comparison of this difference with the maximum distance between two vehicles. MaxDist is used to define how close the vehicles must be in order to be deemed to participate in a platoon. If this distance is assumed to be 100 metres between two vehicles, MaxDist shall be set as 100 metres for a platoon with two vehicles. For platoons with three vehicles, MaxDist becomes 200 metres, for four vehicles 300 metres, and so on.

According to one embodiment, a limit value for position data comprises a minimum distance MinDist between two vehicles. The method comprises a determination of the difference in distance between two vehicles, and a comparison of this difference with the minimum distance between two vehicles. MinDist specifies the minimum distance between two vehicles in a platoon. This should be 0, but if it is known that the vehicles for example are never closer to each other than 10 metres, MinDist may be set as 10. This may prevent erroneously including meeting or passing vehicles in the platoon. The risk of this occurring is small and, according to one embodiment, also handled by the limit values DeltaTime and HeadingDev, which will be explained below.

According to one embodiment, a limit value for directional data comprises a maximum discrepancy HeadingDev between two vehicles. The method then comprises a determination of the difference in directional data between two vehicles, and a comparison of this difference with the maximum discrepancy. If the difference is less or equal to the directional data for the maximum discrepancy, the vehicles are assumed to be travelling in the same direction.

According to one embodiment, the limit value specified relates to the discrepancy in degrees in both a positive and a negative direction. In FIG. 3, an example is illustrated where a vehicle V₀ is the reference vehicle. In this example, HeadingDev is set at 45°, which means that vehicles within a sector of a total of 90° around the direction for V₀ are deemed to be travelling in the same direction as the vehicle V₀. In FIG. 3, two vehicles V₁ and V₂ are illustrated, which are both deemed to be travelling in the same direction as the vehicle V₀. The vehicles Vₓ and V_{y} illustrated in FIG. 3 are not deemed to be travelling in the same direction as the vehicle V₀. The limit value for directional data denominated herein as HeadingDev may, according to one embodiment, assume a value of between 0° and 180°, preferably between 0° and 90°, and more preferably between 0° and 45°. According to one embodiment, HeadingDev is adapted to the design of the road. If the road is very curvy, with for example roundabouts and sharp bends, the direction specified for the vehicle in question may not coincide with the general travelling direction. HeadingDev may then be reduced to a lower value, for example, between 0° and 10°, for example 1, 3, 5, 7, 9°. In this way, there is a smaller interval within which the vehicle is deemed to have the same direction, and the number of vehicles which are erroneously assumed to have the same direction may be reduced.

In FIG. 1, a third step C is shown, where at least a selection of vehicles is identified from the above described group of vehicles depending on the result of the comparison. According to one embodiment, a number of comparisons is made between vehicle data and different limit values for these, and the said selection of vehicles is identified depending on the result of the comparisons. In step B, the method thus starts with vehicle data for a group of vehicles, and in step C one or several are selected out of this group of vehicles. Below, a reference vehicle V₀ will be specified as the vehicle with which the method starts, but it is understood that there may be a large number of vehicles in the group of vehicles that are analyzed. The method may thus use one reference vehicle V₀ at a time, and then changes reference vehicles, preferably until the entire group of vehicles has been reviewed. The selection may for example be set at 10 vehicles, but may also be any other suitable number of vehicles between 2 and 100, or another number of vehicles. If there is no vehicle which is qualified to belong to the platoon in question, the vehicle V₀ is deemed not to belong to any platoon. According to one embodiment, several vehicle selections are made.

In a fourth step D, the distances between the vehicles in the said selection of vehicles are calculated. When the selection comprises 10 vehicles, 9 distances between the vehicles in the selection are calculated. According to one embodiment, the method comprises calculation of the distances D between the vehicles with the help of the following Haversine-formula (1):

$$D = R \cdot \sqrt{( \begin{matrix}{( \frac{( Lat 1 - Lat 2 ) \cdot π}{180} \cdot cos ( \frac{( Long 1 - Long 2 ) \cdot π}{360} ) )}^{2} + \\ {( \frac{( Long 1 - Long 2 ) \cdot π}{180} )}^{2}\end{matrix} )} \qquad ( 1 )$$

where R is the earth's radius 6371000 metres, Lat1 is the reference vehicle's position in latitude coordinates, Long1 is the reference vehicle's position in longitude coordinates, Lat2 is the position in latitude coordinates for the vehicle in question to which the distance is calculated, and Long2 position in longitude coordinates for the vehicle in question to which the distance is calculated. The above formula (1) is a simplified variant of a Haversine formula, assuming that it is possible to calculate the distance with the original version of the Haversine formula, or some other distance calculation method.

In a fifth step E, the relative positions for the vehicles in the said selection of vehicles are determined based at least on the said calculated distances. Thus, when the distances to for example the 10 nearest vehicles are calculated, the relative positions for the vehicles in the platoon are also calculated. The first step is to establish which vehicles are in front and which are behind the reference vehicle V₀, respectively. According to one embodiment, the step to determine the relative positions for the vehicles comprises a comparison of directional data and position data for the vehicles, and a determination of the vehicles' relative position based on the result of these comparisons. This is carried out by first establishing the compass direction into which V₀ is moving, as exemplified in FIG. 2. Vehicles with a direction of between 315° and 45° may be said to have a northerly course. These vehicles will always have an increasing latitude as they move northward. Vehicles in front therefore have a larger latitude, while vehicles behind have a smaller latitude, compared to V₀. The reverse is true for vehicles with a southerly course of between 135° and 225°. Here the latitude instead decreases when the vehicles move southward. These rules for latitudes apply to the northern hemisphere.

The same applies to vehicles on an easterly (45°-135°) and westerly (225°-315°) course. Here the longitude increases for vehicles in an easterly direction. Vehicles in front have a larger longitude, and vehicles behind have a smaller longitude. For vehicles with a western direction on the other hand, the longitude decreases. These rules for longitude apply east of 0°, Greenwich.

With the help of these assumptions about how direction affects latitude and longitude, it is possible to determine whether a vehicle is in front or behind another vehicle and subsequently to establish the relative positions for all vehicles in a platoon. Vehicles in front have a negative distance in relation to V₀, while vehicles behind have a positive distance in relation to V₀.

TABLE 1

| VID | Lat | Long | H | PosTime | DiV1 | DiV2 | DiV3 | DiV4 | DiV5 |
|---|---|---|---|---|---|---|---|---|---|
| 204 | 57.67 | 14.17 | 225 | 2012-03-01 | −9,439 | 9,475 | 28,526 | NULL | NULL |
| | | | | 12:00:00.00 | | | | | |
| 204 | 57.62 | 14.15 | 225 | 2012-03-01 | −9,475 | 9,475 | 28,491 | NULL | NULL |
| | | | | 12:10:00.003 | | | | | |
| 204 | 57.57 | 14.13 | 225 | 2012-03-01 | −9,476 | 9,476 | 28,493 | NULL | NULL |
| | | | | 12:20:00.003 | | | | | |
| 204 | 57.52 | 14.12 | 225 | 2012-03-01 | −9,441 | 9,477 | 28,531 | NULL | NULL |
| | | | | 12:30:00.003 | | | | | |
| 204 | 57.47 | 14.10 | 225 | 2012-03-01 | −9,477 | 9,477 | 28,497 | NULL | NULL |
| | | | | 12:40:00.007 | | | | | |

Table 1 shows an example of a result of the method for a vehicle 204. Thus, the identity VID for the vehicle is here 204. The position data for the vehicle is given in latitude (Lat) and longitude (Long) and directional data (H) in degrees. Time data (PosTime) are specified for each position and direction. Each row in the table thus contains identity, position and direction for a reference vehicle V₀. Here the reference vehicle V₀ is the same vehicle 204 at different times. With this method a selection of five vehicles has been chosen, V1-V5, which were found to be closest to V₀ in a platoon after such vehicle data were compared to (a) limit value(s). According to the embodiment disclosed here, the vehicles must meet all the criteria and be within the maximum and minimum distances from V₀ (MaxDist and MinDist), and report their positions within a specified time interval (DeltaTime) in relation to V₀'s time (PosTime). Sometimes there are no or only a few vehicles within these intervals, so that data for the vehicles may be missing. In this case, data for the vehicles V4 and V5 are missing. In other words, there are no data in the distance fields DiV4 and DiV5. A vehicle which is in front of V₀ will have a negative distance from V₀. In the example, V1 is in front of V₀. A vehicle which is behind V₀ will have a positive distance from V₀. In the example, the vehicles V2 and V3 are behind V₀. The data in the example show that the vehicle 204 (V₀) has been travelling in a platoon consisting of four vehicles. The vehicle V1 has occupied the first position in the platoon, around 9 metres in front of V₀. V₀ has occupied position two in the platoon. The vehicle V2 has occupied position three in the platoon, around 9 metres behind V₀, and the vehicle V3 has occupied position four in the platoon, around 28 metres behind V₀. With this method it is thus also possible to determine how many vehicles participate in the platoon.

According to one embodiment, the method comprises the additional steps of: determining the fuel consumption for the vehicles in the said selection, comparing the fuel consumption for the vehicles in the selection at least in relation to their relative established positions, and determining at least one fuel consumption result based on the said comparison, which indicates a fuel saving in relation to the said relative established position. The fuel consumption for the respective vehicles may, for example, be collected from a data base, or via wireless transfer directly from the respective vehicles. Fuel consumption results may, for example, comprise the amount of saved fuel as a percentage, and be connected to the position within the platoon.

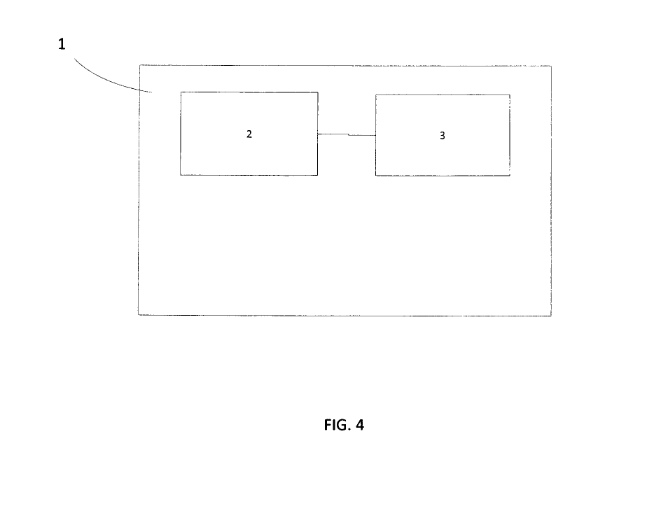

The invention also comprises a computer system 1 in connection with the occurrence of platoons, and will now be explained with reference to FIG. 4. The computer system comprises a memory device 3 and a processor device 2, which is configured to communicate with the memory device 3. The processor device 2 is configured to provide a number of sets of vehicle data in relation to a number of vehicles. These sets may for example be collected from a database, which may be stored in the memory device 3, or some other memory device. Alternatively the processor device may be configured to receive wireless signals indicating the said vehicle data from one or several devices in the vehicles from among the group of vehicles, or from a road side device. According to one embodiment, the said vehicle data comprises one or several of identity, position data, directional data and time data for each vehicle. The position data is preferably obtained from GPS (Global Positioning System) and comprises geographical coordinates for the respective vehicles.

The processor device is also configured to compare the sets of vehicle data for the group of vehicles with at least one limit value for the vehicle data, and to determine at least a selection of vehicles from among the group of vehicles depending on the result of the comparison. According to one embodiment, several vehicle selections are made from the group. According to one embodiment, the limit value or values comprise limit values for position data, directional data and/or time data. These limit values may for example be determined in relation to a reference vehicle V₀. The processor device is then configured to calculate the distances between the vehicles in the said selection or selections of vehicles, and to determine the relative positions for the vehicles in the selection or selections of vehicles based at least on the calculated distances. The processor device may, for example, be configured to calculate the distances between the vehicles with the help of a Haversine formula (1), which has been described in connection with the method.

According to one embodiment, the processor device is configured to compare directional data and position data for the vehicles and to determine the vehicles' relative position based on the result of these comparisons. Thus, it is possible to find out how the calculated distances between the vehicles relate to each other, and thus their relative position within the platoon.

According to one embodiment, the processor device is configured to determine the fuel consumption for the vehicles in the said selection, to compare the consumption for the vehicles in the selection at least in relation to their relative established position, and to determine at least one fuel consumption result based on the said comparison which indicates a saving of fuel in relation to the said relative determined position. The processor device is also configured to generate a result signal which indicates the fuel consumption result. Thus, it is possible for example to show the fuel consumption result on a display connected to the computer system. The fuel consumption may for example be shown as a percentage related to the vehicles mutual relation in the platoon.

The invention also comprises a computer program product which comprises computer program instructions to induce a computer system to carry out the steps according to the method described above, when the computer program instructions are executed on the computer system. According to one embodiment the computer program instructions are stored in a non-transitory computer readable medium readable by a computer system.

The present invention is not limited to the embodiments described above. Various alternatives, modifications and equivalents may be used. The embodiments above therefore do not limit the scope of the invention, which is defined by the enclosed patent claims.

1. A computerized method to determine that a platoon of vehicles has occurred, the method comprising:
providing a number of sets of vehicle data in relation to a number of vehicles;
comparing said sets of vehicle data for said number of vehicles with at least one limit value for said sets of vehicle data;
determining that a platoon of vehicles has occurred by determining at least a selection of vehicles from said number of vehicles depending on the result of said comparison;
calculating the distances between the vehicles in said selection of vehicles; and
determining the relative positions for the vehicles in said selection of vehicles based at least on said calculated distances.

2. A method according to claim 1, wherein said vehicle data for each vehicle comprises at least one of identity, position data, directional data and time data.

3. A method according to claim 1, wherein determining the relative positions for the vehicles comprises a comparison of directional data and position data for the vehicles and a determination of the vehicles' relative position based on the result of the comparisons.

4. A method according to claim 1, wherein said at least one limit value comprises at least one of limit value for position data, directional data and time data.

5. A method according to claim 1, further comprising calculating said distance between the vehicles with a Haversine formula.

6. A method according to claim 2, wherein said position data comprises geographical coordinates for the respective vehicles.

7. A method according to claim 1, further comprising:
determining the fuel consumption for the vehicles in said selection;
comparing the fuel consumption for the vehicles in the selection at least in relation to their relative established positions; and
determining at least one result parameter based on said comparison, which indicates a saving of fuel in relation to said relative established position.

8. A computer system configured to determine the occurrence of a platoon of vehicles, the system comprising a memory device and a processor device which is configured to communicate with the memory device, wherein the processor device is configured to:
provide a number of sets of vehicle data in relation to a number of vehicles;
compare the said sets of vehicle data for said number of vehicles with at least one limit value for the vehicle data;
determine that a platoon of vehicles has occurred by determining at least a selection of vehicles from the number of vehicles depending on the result of said comparison;
calculate the distances between the vehicles in said selection of vehicles; and
determine the relative positions for the vehicles in said selection of vehicles based at least on said calculated distances.

9. A computer system according to claim 8, wherein said vehicle data comprises at least one of identity, position data, directional data and time data for each vehicle.

10. A computer system according to claim 8, wherein the processor device is configured to compare directional data and position data for the vehicles and to determine the vehicles' relative position based on the result of the comparisons.

11. A computer system according to claim 8, wherein said at least one limit value comprises at least one of limit value for position data, directional data and time data.

12. A computer system according to claim 8, wherein the processor device is configured to calculate said distance between the vehicles with a Haversine formula.

13. A computer system according to claim 9, wherein said position data comprises geographical coordinates for the respective vehicles.

14. A computer system according to claim 8, wherein the processor device is further configured to:
determine the fuel consumption for the vehicles in said selection;
compare the fuel consumption for the vehicles in the selection at least in relation to their relative established positions; and
determine at least one result parameter based on said comparison, which indicates a saving of fuel in relation to the said relative established position.

15. A computer program product which comprises a non-transitory computer readable medium and computer program instructions stored in the medium to induce a computer system to carry out the steps according to the method of claim 1, when the computer program instructions are executed on the computer system.

16. (canceled)

17. A method according to claim 1, wherein the sets of vehicle data are provided to a processor, and further comprising performing the comparing, the determining that a platoon of vehicles has occurred, the calculating, and the determining the relative positions for the vehicles with the processor.

18. A method according to claim 17, further comprising generating with the processor a result signal indicating fuel consumption, and displaying with a display a fuel consumption result for a vehicle in the platoon.

19. A computer system according to claim 8, wherein the processor is configured to generate a result signal indicating fuel consumption, and further comprising a display that displays a fuel consumption result for a vehicle in the platoon.
